(19) United States
(12) Patent Application Publication
(10) Pub. No.: US 2010/0211428 A1
(43) Pub. Date: Aug. 19, 2010

(54) Automated Customer Service Matching Methodology

(75) Inventors: Maureen Emily Duffy, Westford, MA (US); David C. Mair, Wake Forest, NC (US); Richard P. Statile, Raleigh, NC (US); Pamela J. Watrous, Apex, NC (US)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(73) Assignee: Red Hat, Inc., Raleigh, NC (US)

(21) Appl. No.: 12/388,424

(22) Filed: Feb. 18, 2009

(51) Int. Cl. G06Q 10/00; G06Q 50/00

(52) U.S. Cl. 705/9

(57) ABSTRACT

Described herein is a method and apparatus for providing an automated customer service matching system. The customer service system matches customer services requests with employee profiles. The customer service system provides a graphical user interface for monitor the management of customer service requests. The customer service system also includes a process for registering employees and creating employee profiles, as well as a system for registering customers and creating or matching a customer with the customer profile.

### TECHNICAL FIELD

Embodiments of the present invention relate to a method and system for managing customer service. Specifically, embodiments of the present invention relate to a system for automated matching of employees with customer service requests.

### BACKGROUND

Some companies provide ongoing customer support for their products. Many companies provide a generic customer service through the use of call centers and help desks. In these cases, customers call into the help center or approach a help desk to obtain assistance with their product. The employee of the company that is interfacing with the customer typically varies each time that the call center or help desk is contacted. If the request cannot be completely resolved in a single call or meeting, then the employee handling the customer service request will change in the majority of cases with each call or meeting.

Other companies offer dedicated customer service representatives to some customers and for some products. A particular representative may be assigned to service requests from a particular company or customer. In this manner, the customer has an established relationship with their customer representative. However, these customer representatives may not be the most knowledgeable or up-to-date on many of the issues faced by the customer, especially if the customer uses a wide range of the company's products or if the products are complex or change rapidly.

Some companies offer a combination of these services. However, whatever combination is offered these options are minimally automated. The specific customer service requests, sometimes referred to as tickets, can be logged and tracked in a system. This allows different customer service representatives to review the progress and status of the customer service requests. The customer service requests are assigned by placement in queues and serviced in order of request receipt or priority. The next available customer service representative takes the request at the front of the queue or it is manually assigned to the next available customer service representative.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a diagram of one embodiment of a system for providing customer service.

FIG. 2 is a flowchart of one embodiment of the process for employee registration with the customer service system.

FIG. 3 is a flowchart of one embodiment of the process for a customer to register with the customer service system.

FIG. 4 is a flowchart of one embodiment of the process for matching customer service requests with available employees.

FIG. 5 is a diagram of one embodiment of a graphical user interface for the customer service system that is offered to employees.

FIG. 6 is a diagram of one embodiment of a graphical user interface for the customer service system that is offered to a customer.

FIG. 7 is a diagram of one embodiment of a computer system for customer service management.

### DETAILED DESCRIPTION

Described herein is a method and apparatus for providing an automated customer service system. The customer service system matches customer services requests with employee profiles. The customer service system provides a graphical user interface for monitoring the management of customer service requests. The customer service system also includes a process for registering employees and creating employee profiles, as well as a system for registering customers and creating or matching a customer with an existing customer profile.

As used herein an “employee,” refers to an employee of a company or similar entity that provides a product or service to a “customer,” As used herein a “customer,” refers to any entity that receives the product or service from the company. One skilled in the art would understand that any company or other entity can be a customer of a given product or service. Similarly, any company can be a provider of a product or service and provide customer service through a group of employees of the company.

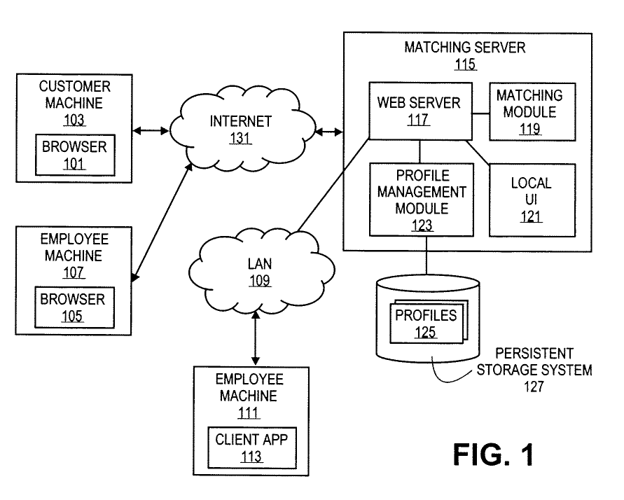

FIG. 1 is a diagram of one embodiment of the customer service system. The customer service system includes a matching server 115 that is accessible over at least one network. The matching server 115 may be accessible to customer machines 103 and employee machines 107 and 111. The matching server 115 may be in communication with or encompass a persistent storage system 127 for storing customer and employee profiles 125. The matching server 115 can be accessible through any type of network including a local area network 109 or wide area network, such as the Internet 131, or similar communication system. The connected networks can include any combination of wireless and wired components.

The matching server 115 includes a web server 117, matching module 119, local user interface 121, profile management module 123 and similar components. The matching server 115 can be a desktop computer, laptop computer, server or similar computing device. In one embodiment, the matching server 115 is located on a single computing device. In other embodiments, the matching server 115 may be distributed across multiple computing devices. The persistent storage system 127 can be a set of internal or external storage devices, such as optical or magnetic storage devices, or can be an array of internal or external storage devices and any combination thereof. In addition to the profiles 125 that can be stored in the persistent storage system 127, a portion or whole of the constituent components of the matching server 115 can be stored or backed up onto the persistent storage system 127.

The web server 117 provides an interface in the form of a set of web pages for the customer service system. The web server 117 offers a set of monitoring management and user interface options through the web pages. The web server based user interface offered to the customer machine 103 and employee machines 107 and 111 can be solely in the form of interactive web-based content that gives the customers and employees account based access to the other components of the matching server 115. The use of web pages and web server 117 enable customer machines 103, 111 to access the customer service system user general purpose browsers 101, 105. In another embodiment, the matching server 115 has a dedicated remote user interface system that enables access of the functionality of the other modules of the matching server 115 to remote computers 103, 107 and 111. The dedicated remote user interface includes a dedicated customer application 113 to access a dedicated user interface module provided by the matching server 115.

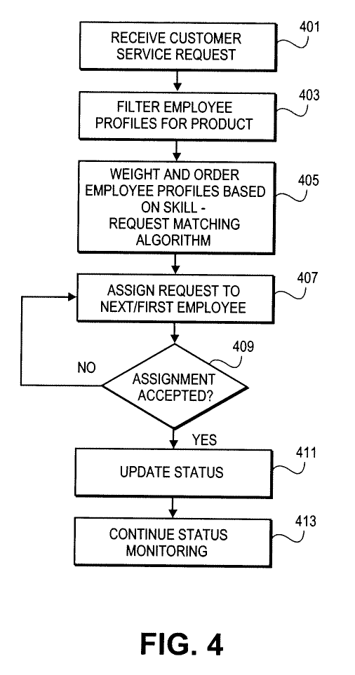

The matching module 119 manages the assignment of customer service requests to employees. The matching module 119 tracks the customer service requests and provides status information through the web server 117 or a similar user interface module. The matching module 119 can access the customer profiles and employee profiles by generating requests or queries to be serviced by the profile management module 123. The functions of the matching module 119 are discussed further in regard to FIG. 4.

Local user interface 121 provides access to a user of the matching server 115 through a local terminal on the hosting machine itself. The local user interface 121 can interact with the functionality of the matching server 115 and overall customer service system through the web server 117 or through direct interaction with the other components of the matching server 115. The local user interface 121 can be a graphical user interface, a command line interface or similar user interface.

The profile management module 123 manages access and storage of customer and employee profiles 125 in the persistent storage system 127. The profile management module 123 also assists in the matching of existing customer or employee profiles through the respective registration processes. The profile management module 123 can provide access to profile information 125 and enable the update of profile information through the web server 117 or similar user interface component of the matching server 115.

The profiles 125 on the persistent storage system 127 contain information about customers and employees that is relevant to the matching of customer service requests to employees. Customer profiles can include information about the products utilized by the customer, customer contact information, customer demographic information, customer location information, customer industry or domain, current customer service requests, customer service request preferences and similar information. Employee profiles can include biographical and demographic information, skill set information, availability information, contact information, experience with particular industries, domains or fields, product and project experience, and similar employee-related information.

The customer machine 103 can be any type of computing device, including a desktop computer, laptop computer, workstation, server, console device, handheld device or similar computing device. Customer machine 103 can provide access and interact with the customer service system through the matching server 115 and, specifically, through the web server 117 by providing a general purpose browser 101 or similar application. In another embodiment, the customer machine 103 provides a client-side application that is specific to or part of an application adapted to work with and provide access to the customer service system through a user interface module of the matching server 115.

The employee machines 107 and 111 can be connected to the matching server 115 through the wide area network, such as Internet 131, or through a local area network (LAN) within the company. Different levels of security protocols can be utilized for accessing matching server services and data depending on the location of customers and employees. Customers and employees accessing these services over the Internet may have reduced access or services to protect the data of the matching server 115 from attack. Employees or customers accessing the matching server 115 over a LAN or virtual private network or similar connection may have expanded access to matching server 115 data.

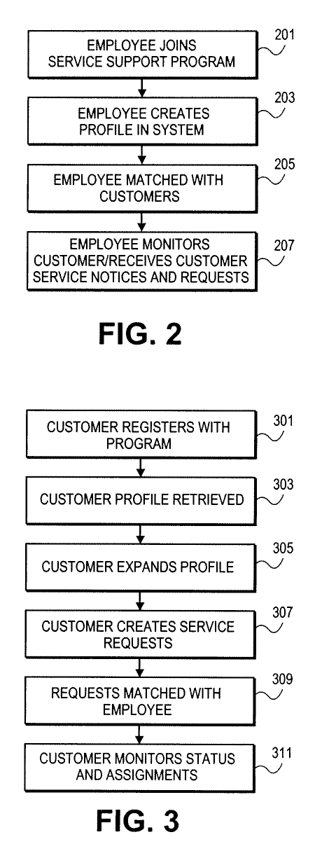

FIG. 2 is a flowchart of one embodiment of the process for employee registration with the customer service system. Employee participation in the customer service system may be optional or voluntary. In cases where employee participation is mandated, the system is set up to require the employee to register with the system. The employee can decide to either create a profile or to claim an existing profile that had already been generated for the employee based on employer data on file for the employee. The employee can join the customer service support program by creating a log-in or similarly creating a user account with the customer service program (block 201). Each employee is given their own account and is able to update or modify their profiles. This can include adding biographical and demographic data, job experience information, skill sets information, information on current projects and products that the employee is working on, experience in industries, fields and domains related to the company's current customer base, and similar information relevant to the matching of the employee with a customer or set of customers and with particular customer service requests. Entering this data into the system creates or completes a profile for the employee within the customer service system (block 203). This profile is stored in the persistent storage system.

In one embodiment, after the profile has been created, the employee is matched with a specific customer (block 205). In this embodiment, the employee is matched with a specific customer or set of customers based on the comparison of the employee profile with customer profiles. The comparison looks for matches in terms of products utilized by the customer, and those worked on by the employee or with which the employee has expertise. The matching can also take into consideration other factors such as location of the employee relative to the customer, the availability or work schedule of the employee, the employee's level of skill or experience in the customer's industry, field or domain, and similar factors. Matching the employee with the customer puts the employee into a pool of employees that will service the requests of the customer and can maintain a dedicated relationship with representatives of that customer. As used herein, “customer representatives” refers to an individual that represents the customer, i.e., an employee of the customer.

Once the employee is registered with the system, has a profile, and is optionally matched with a customer, the employee monitors their user account to determine when customer service requests have been entered into the system, or receives notice that customer service requests have been entered into the system (block 207). The employee will see the results of the matching algorithm and have the option of accepting a matching customer service request that has been assigned to the employee or denying the match. The employee will also have the ability to update and maintain the information on assigned customer service requests that the employee accepts. Additional details of the ongoing use of the system are discussed further in regard to FIG. 4.

FIG. 3 is a flowchart of one embodiment of a process for customer registration. In one embodiment, the customer registration process is initiated by a customer who wishes to take part in the customer service system. The customer accesses the matching server to create a customer account. Creating a customer account includes inputting basic customer information, which begins the registration process (block 301). The basic customer information is utilized to search existing customer profiles and retrieve a matching profile (block 303). A customer profile may exist prior to the customer registration for purposes of monitoring customer service requests that are received outside of the customer service system or automatically generated based on the company's stored data on that customer's account outside of the customer service system.

Once the customer profile has been created or retrieved, the customer can expand the profile with additional information including customer contact information, customer representative information, products of interest to the customer or in use by the customer, customer demographic information, customer industry, field or domain, and similar information relevant to matching the customers' needs with employee profiles. A customer can expand the profile (block 305) by providing a customer information file or by interface mechanisms provided by the web server of the matching server.

Once the customer has updated the corresponding customer service profile, the customer can create new customer service requests (block 307). The customer service requests are for specific problems or issues that the customer has encountered using a product or service offered by the company. These requests are placed in the system and ultimately matched with an employee of the company (block 309). The matching of the employee with customer service requests is made based on the skills, availability and similar profile information provided by the employee. The customer can continually monitor the status and assignment of the customer service requests through the customer interface provided by the matching server, or alternatively may receive notifications with status and other informational updates or action reminders on their requests. Also, the representatives of the customer can utilize the information provided by the customer service system to call or similarly contact the employee who has been assigned to a customer service request.

FIG. 4 is a flowchart of one embodiment of a process for matching a customer service request with a profile. In one embodiment, the process is initiated in response to receiving a customer service request (block 401). A customer service request can be generated by the customer through the user interface offered to the customer by the customer service system. In another embodiment, the customer's service request can be entered into the system by a call center or employee of the company. These alternate options can be utilized when the customer has not completed the registration process or does not utilize the customer service system directly.

The process continues by filtering registered employee profiles to create a pool of employee profiles that have expertise with the product that is related to the customer service request (block 403). Additional filtering can be utilized to further narrow the pool of employee profiles. For example, employee profiles can be further filtered to those profiles for employees who have been assigned to a specific customer. In other embodiments, the filter is broadened if too few employee profiles are found in the initial filtering. The filtering can be expanded to include products that are similar or analogous to those products identified by the customer service request. Similarly the filter can be expanded to match the customer service request based on similar skills or experience held by employees.

The employee profiles can be organized based on listed skills and similar profile elements relevant to the request matching algorithm (block 405). In one embodiment, the customer can specify the parameters for the request matching algorithm, provide a specific request matching algorithm or just provide preferences for executing or configuring the request matching algorithm. For example, the parameters of the matching algorithm can perform the matching based on employee product assignment, experience and availability. The request matching algorithm generates an ordered data structure of the available employees and the first available employee is assigned to a received request (block 407). The selected employee user account is updated to reflect that the customer request has been assigned to that employee or is in the inbox or queue of that employee. The employee has a designated amount of time to accept the assignment (block 409). If the employee is unable to take on the assignment, then the employee can refuse the assignment. Similarly, the employee may not be actively monitoring his account or may be on vacation or may leave the company, in which case a time-out can be used to automatically decline the assignment or pass on an already assigned request. In this case, the next employee in the queue or list is selected and this process continues until an employee accepts the assignment of a customer service request. In other words, the customer service request is reassigned after the time-out period expires.

Once an employee has accepted an assignment of a customer service request, the status of the customer service request is updated to reflect information about the employee assigned to the customer service request (block 411). This update can be automatic or can be done by the employee upon accepting the assignment. The customer can continue to review and receive status updates regarding the customer service requests as they are updated by the employee (block 413). In one embodiment, an update of a customer service request can be provided to the customer by an automatic notification system. In another embodiment, the customer must log into the system to receive or view these updates.

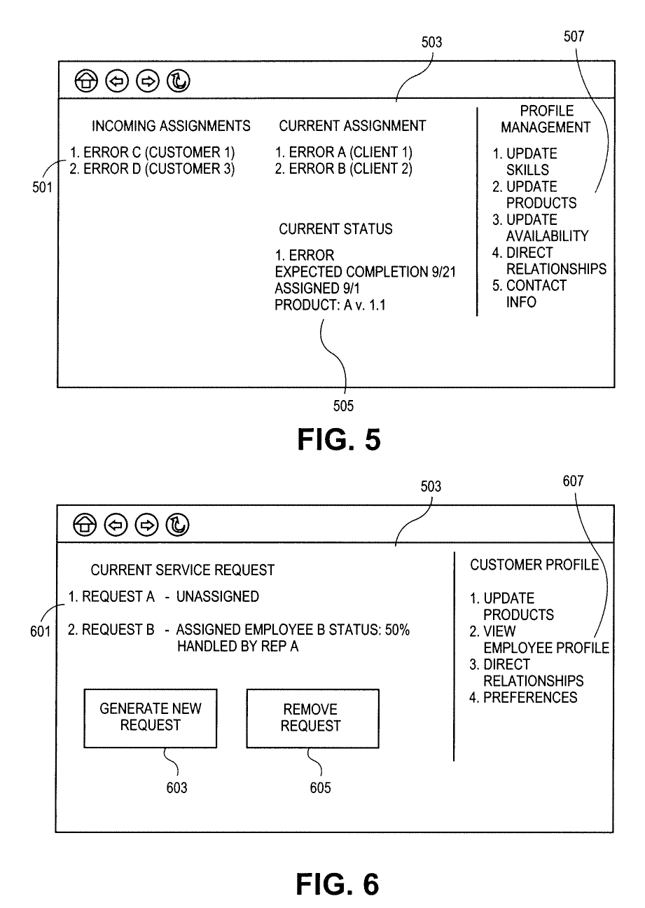

FIG. 5 is a diagram of one embodiment of a graphical user interface for the management of employee profile information and customer service requests. In one embodiment, the graphical user interface is provided through a browser. In another embodiment, the graphical user interface is provided through an application-specific client. The employee management interface includes a list of incoming assignments 501, a list of current assignments 503, a current status information panel 505, a set of profile management options 507 and similar data and user interface elements.

The incoming assignments list 501 lists each of the assignments in date order or similar order that the request matching algorithm has selected the employee to service. The employee can utilize this list 501 to select an incoming assignment of a customer service request and enter an acceptance of the assignment or decline the assignment. This acceptance or refusal can be managed by any type of user interface mechanism, including a separate pop-up window menu, a simple check box, a radio button, a submit button, acceptance or refusal button, or similar user interface element or combinations thereof.

The current assignment list 503, lists each of the customer service request assignments that have been accepted by the employee and may provide some descriptive information about each of the assignments, such as the type of issue or the customer that is associated with the assignment and the current state of the request. Selecting one of the assignments can bring up additional information in the current status panel 505 or similar user interface element. The current status panel 505 can include information regarding the issue, estimated completion date, assignment date, product information, and similar information related to the customer service request. This current status panel 505 can be interactive allowing the employee to update any of the information therein, which can then be promulgated through the system and made available to the customer. In one embodiment, the changing of this data may also instigate the generation of an automated message to the customer to notify them of a change in the status of their customer service request. Such automated messages may be issued in response to certain types of changes, or may only be initiated in response to a specific direction or instruction of the employee.

The profile management menu 507 provides a set of menu options and user interface options for enabling the employee to update and change the employee's profile so that the employee profile reflects up-to-date information and can ensure that the best matches are made between customer service requests and available employees. Profile management tools can include menus for updating employee skills, updating the products the employee has knowledge or expertise in, update the availability information of the employee, such as workload and vacation information update, update contact information, update direct relationship information and similar tools and information modification interfaces. This interface, as well as, the other profile management interfaces can initiate a pop-up interface or generate a replacement web-page to provide a set of text boxes or dialog boxes that allow a user to modify and input profile data. The direct relation interface allows the employees to find representatives of the customers or other entities that the employee has directly interacted with previously. This can play a role in the selection of the employee for additional projects or requests where that relationship is relevant to the request or project. In one embodiment, employee profile data may also be updated automatically based on the update of employee information within another application within the company's network. For example, if the employee leaves the company, the employee profile in the customer service management system can be automatically updated accordingly and may initiate a reassignment of the assignments of the employee.

FIG. 6 is a diagram of one embodiment of a graphical user interface for the customer service system that allows the customer to manage customer service requests and its customer profile. The customer service interface includes a listing of current service requests 601, a generate new request option 603 and a remove request option 605, as well as, a current set of customer profile tools 607.

The current service request 601 provides a quick synopsis of each of the current service requests that have been submitted, as well as their status. For example, an illustrated list of current service requests includes a first Request A that is designated as unassigned and a second Request B that is designated as assigned to a specific employee. In addition, information such as the status, assigned customer representative and similar information is displayed. In another embodiment, the current service request list 601 can be utilized to prioritize the service requests to ensure that the highest priority customer service requests are assigned first and to give notice to assigned employees of the importance of the current service request to the customers.

A generate new request user interface element 603 is a menu item or similar user interface item that allows the customer to initiate a new customer service request. This new request may be further completed through a subsequent page or menu that allows the relevant details of the request to be input into the system, and which will automatically be processed to generate a match with an employee and subsequently utilized to update the current service request list 601. Similarly, the remove request user interface element 605 allows the user to rescind or remove a request that is in the current service request list 601. The request can be completely removed or, in another embodiment, the request is simply deactivated temporarily allowing the customer to update or change the service request. In another embodiment, the remove request user interface element may allow the customer to remove parts of a request into other new requests, in order to split up complex or multi-faceted issues.

The customer profile menu 607 lists a set of menu items, tools or interface mechanisms that allow the customer to update its profile. The menu items, tools include an interface for updating products that the customer utilizes, the employee profiles of the company generally or those employees assigned to their requests, a tool to designate direct relationships between the customer representatives and employees of the customer profile, and a preferences option that allows the customer to specify the methods or the importance of different factors in assigning an employee to a service request, which can effect directly or indirectly the request matching algorithm.

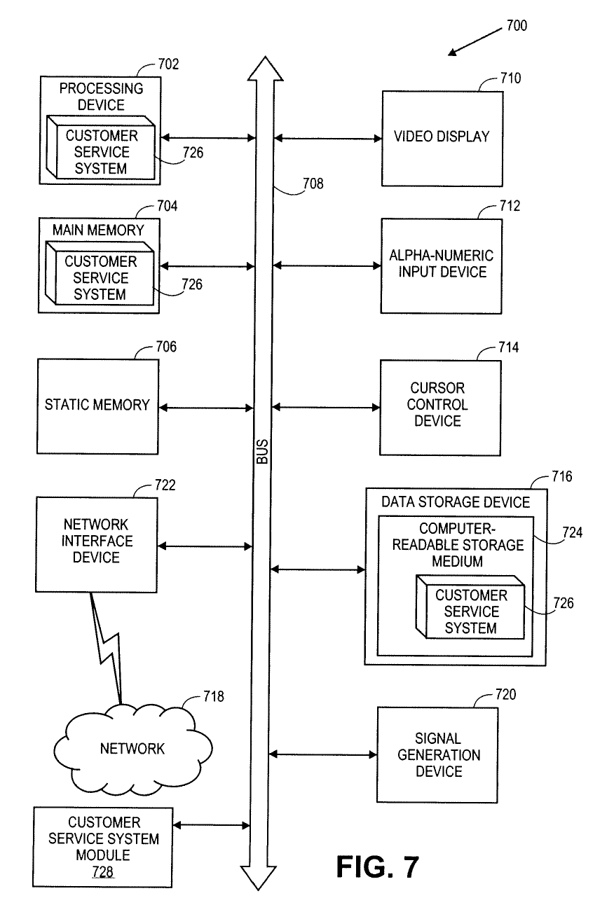

FIG. 7 is a diagram of one embodiment of a computer system for customer service management. Within the computer system 700 is a set of instructions for causing the machine to perform any one or more of the methodologies discussed herein. In alternative embodiments, the machine may be connected (e.g., networked) to other machines in a LAN, an intranet, an extranet, or the Internet. The machine may operate in the capacity of a server or a client machine (e.g., a client computer executing the desktop management program and the server computer executing the a remote application) in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a secondary memory 716 (e.g., a data storage device in the form of a drive unit, which may include fixed or removable computer-readable storage medium), which communicate with each other via a bus 708.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, processing device implementing other instruction sets, or processing devices implementing a combination of instruction sets. Processing device 702 may also be one or more special-purpose processing devices such as an application specific integrated circuit (ASIC), a field programmable gate array (FPGA), a digital signal processor (DSP), network processor, or the like. Processing device 702 is configured to execute the customer service management system 726 for performing the operations and steps discussed herein.

The computer system 700 may further include a network interface device 722. The computer system 700 also may include a video display unit 710 (e.g., a liquid crystal display (LCD) or a cathode ray tube (CRT)) connected to the computer system through a graphics port and graphics chipset, an alphanumeric input device 712 (e.g., a keyboard), a cursor control device 714 (e.g., a mouse), and a signal generation device 720 (e.g., a speaker).

The secondary memory 716 may include a computer-readable storage medium (or more specifically a computer-readable storage medium) 724 on which is stored one or more sets of instructions (e.g., the customer service management system 726) embodying any one or more of the methodologies or functions described herein. The customer service management system 726 may also reside, completely or at least partially, within the main memory 704 and/or within the processing device 702 during execution thereof by the computer system 700, the main memory 704 and the processing device 702 also constituting computer-readable storage media. The customer service management system 726 may further be transmitted or received over a network 718 via the network interface device 722.

The computer-readable storage medium 724 may also be used to store the customer service management system persistently. While the computer-readable storage medium 726 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The modules 728, components and other features described herein (for example in relation to FIG. 1) can be implemented as discrete hardware components or integrated in the functionality of hardware components such as ASICS, FPGAs, DSPs or similar devices. In addition, the modules 728 can be implemented as firmware or functional circuitry within hardware devices. Further, the modules 728 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention. It should be noted that different references to “an” or “one” embodiment in this disclosure are not necessarily to the same embodiment, and such references mean at least one.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “storing,” “matching,” “assigning,” “generating,” “filtering,” or the like, refer to the actions and processes of a computer system, or similar electronic computing device that manipulates and transforms data represented as physical (electronic) quantities within the computer system's registers and memories into other data similarly represented as physical quantities within the computer system memories, registers or other such information storage, transmission or display devices.

The present invention also relates to a system for customer service management. This apparatus may be specially constructed for the required purposes or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, Flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Thus, a method and apparatus for customer service management been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
storing an employee profile in a persistent storage system;
matching an employee profile automatically with a customer service request based on employee product assignment, experience, and availability by a matching server; and
assigning the customer service request to the employee.

2. The computer-implemented method of claim 1, further comprising:
generating a query to filter a set of employee profiles.

3. The computer-implemented method of claim 2, further comprising:
filtering the set of employee profiles based on customer correlation, product correlation or experience correlation.

4. The computer-implemented method of claim 1, further comprising:
generating a management interface for the employee.

5. The computer-implemented method of claim 1, wherein matching includes ranking employees by matching criteria.

6. The computer-implemented method of claim 1 further comprises:
reassigning the customer service request after expiration of a time-out period.

7. The computer-implemented method of claim 1, further comprising: generating an interface for customer management of customer service requests.

8. The computer-implemented method of claim 1, further comprising:
generating a registration interface for an employee or a customer.

9. The computer-implemented method of claim 1, further comprising:
generating an interface for customer profile or employee profile management.

10. A system comprising:
a user interface module for a customer to generate service request management interface; and
a matching module coupled to the user interface module to automatically pair a customer service request with an employee profile based on product assignment, experience and availability.

11. The system of claim 10, further comprising:
a profile management module coupled to the user interface module, the profile management module to store, update and retrieve customer, employee, and customer representative profiles.

12. The system of claim 10, wherein the user interface module is local user interface.

13. A computer-readable storage medium including instructions that, when executed by a computer system, cause the computer system to perform a set of operations comprising:
storing an employee profile in a persisted storage device;
matching an employee profile automatically with a customer service request based on employee product assignment, experience and availability by a matching server and
assigning the customer service request to the employee.

14. The computer-readable storage medium of claim 13, having further instructions thereon, which when executed cause the computer system to perform a set of operations, further comprising:
generating a query to filter a set of employee profiles.

15. The computer-readable storage medium of claim 13, having further instructions thereon, which when executed cause the computer system to perform a set of operations, further comprising:
filtering the set of employee profiles based on customer correlation, product correlation, or experience correlation.

16. The computer-readable storage medium of claim 13, having further instructions thereon, which when executed cause the computer system to perform a set of operations, further comprising:
generating management interface for the employee.

17. The computer-readable storage method of claim 13, wherein matching includes ranking employees by matching criteria.

18. The computer-readable storage medium of claim 13, having further instructions thereon, which when executed cause the computer system to perform a set of operations, further comprising:
reassigning the customer service request after expiration of a time-out period.

19. The computer-readable storage medium of claim 13, having further instructions thereon, which when executed cause the computer system to perform a set of operations, further comprising:
generating an interface for customer management of customer service requests.

20. The computer-readable storage medium of claim 13, having further instructions thereon, which when executed cause the computer system to perform a set of operations, further comprising:
generating a registration interface for an employee or a customer.

21. The computer-readable storage medium of claim 13, having further instructions thereon, which when executed cause the computer system to perform a set of operations, further comprising:
generating an interface for customer profile or employee profile management.
